(19) United States
(12) Patent Application Publication
(10) Pub. No.: US 2006/0077478 A1
(43) Pub. Date: Apr. 13, 2006

(54) Scanning device

(75) Inventors: Chi-hun Kim, Suwon-si (KR); In-gu Kwak, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/236,490

(22) Filed: Sep. 28, 2005

(30) Foreign Application Priority Data
Oct. 9, 2004 (KR) 2004-80673

(51) Int. Cl. H04N 1/04

(52) U.S. Cl. 358/474

(57) ABSTRACT

A scanning device comprises a scanner body including a frame, a cover pivotably mounted to the scanner body so that it can be opened and closed, a scan unit mounted to the scanner body to scan an image of a document, and a grounding unit for grounding a noise radiated from the scan unit to the frame and thereby remove the noise. The grounding unit is selectively connected to the frame according to whether the cover is opened or closed. The connection distance between the grounding member and the frame is reduced as much as possible to prevent induction of radiated EMI by the grounding member, and to achieve effective grounding of the radiated EMI.

### CROSS-REFERENCE TO RELATED APPLICATIONS

This application claims the benefit under 35 U.S.C. § 119(a) of Korean Patent Application Serial No. 2004-80673, filed in the Korean Intellectual Property Office on Oct. 9, 2004, the entire disclosure of which is hereby incorporated by reference.

### BACKGROUND OF THE INVENTION

1. Field of the Invention

The present invention relates to a multifunctional scanner, printer and facsimile apparatus. More particularly, the present invention relates to a scanning device included in a multifunctional apparatus.

2. Description of the Related Art

Generally, multifunctional apparatuses scan a document, store a scanned image, and print or transmit the stored image. To accomplish this, the multifunctional apparatuses include a scanning device. FIG. 1 shows an exemplary scanning device.

The scanning device 1 comprises a main body 1, a scan unit 2, and a shading member 3. The main body 1 has a document tray (not shown) for stacking documents thereon and a hinged cover 1a. An automatic document feeder 1b is mounted to the cover la to supply documents sheet by sheet from a stacked sheet of documents. The main body 1 is mounted on a frame 1c which provides stable grounding of the system. The scan unit 2 is movably mounted in the main body 1 to scan a document stacked on the document tray or a document supplied by the automatic document feeder 1b.

A shading member 3 is disposed opposite the scan unit 2 in the cover 1a to detect a starting point of the scanning operation of the scan unit 2, assign a position for image reduction and enlargement, and compensate white level. The shading member 3 is generally formed as a roller or a bar.

The above-described scanning device generates radiated electromagnetic interference (EMI), especially in the scan unit 2. Radiated EMI is caused by electromagnetic waves emitted from electronic appliances. Excessive radiated EMI may affect the human body and other peripheral electronic parts.

When the cover 1a is closed, a large amount of radiated EMI generated by the scan unit 2 is transmitted to the shading member 3. To ground the radiated EMI which is transmitted to the shading member 3, a grounding cable 3a connects the shading member 3 and the frame 1c of the main body 1. The grounding cable 3a is connected to the shading member 3 and the frame 1c by means such as a screw (not shown).

The grounding cable 3a, together with other cables of the automatic document feeder 1b, is exposed. Furthermore, the grounding cable 3a in a typical apparatus needs to be 30 cm long or longer. The length of the cable causes deterioration of the grounding efficiency.

In other words, because the grounding cable 3a connected to the shading member 3 is too long, the radiated EMI produced by the scan unit 2 cannot be completely grounded. If this happens, the shading member 3 may begin radiating EMI and become another source of noise, thereby increasing the total noise of the scanning device.

Accordingly, there is a need for a scanning device with an improved EMI grounding mechanism.

### SUMMARY OF THE INVENTION

An aspect of the present invention is to solve at least the above problems and/or disadvantages and to provide at least the advantages described below. Accordingly, an aspect of the present invention is to provide a scanning device with an improved grounding mechanism for more effective grounding of radiated EMI generated by a scanning device.

According to an aspect of the present invention, a scanning device comprises a scanner body including a frame, a cover pivotably mounted to the scanner body so that is can be opened and closed, a scan unit mounted to the scanner body to scan an image of a document, and a grounding unit for grounding noise radiated by the scan unit to the frame to thereby remove the noise. The grounding unit is selectively connected to the frame by the opening and closing of the cover.

The grounding unit comprises a grounding member mounted to the cover to face the scan unit, a driving member movably mounted to the scanner body to be contacted with the grounding member, and a grounding cable for connecting the driving member and the frame.

The driving member comprises a ball contacting the grounding member, and a spring biasing the ball into contact with the grounding member when the cover is closed.

The grounding member serves as a shading member to provide a reference for shading compensation to the scan unit. Here, the shading member may be a white bar or a white roller.

The cover has an automatic document feeder for supplying documents to an upper part of the scan unit sheet by sheet. The grounding member is disposed on a moving path of a document being supplied by the automatic document feeder.

A document tray for receiving a document is disposed between the grounding member and the driving member. The document tray has an opening to allow the driving member to move through it.

The grounding member comprises a non-coated portion for contacting the driving member and a coated portion disposed opposite to the scan unit. The coated portion is coated with a certain color.

According to another aspect of the present invention, a scanning device comprises a scanner body including a frame, a cover pivotably mounted to the scanner body so that it can be opened and closed, a scan unit mounted to the scanner body to scan an image of a document, a shading member mounted to the cover to provide a reference for shading compensation to the scan unit, and a grounding unit for grounding the shading member to the frame. The grounding unit is selectively connected to the frame by the opening and closing of the cover.

### BRIEF DESCRIPTION OF THE DRAWING FIGURES

The above and other objects, features, and advantages of certain embodiments of the present invention will be more apparent from the following description taken in conjunction with the accompanying drawings, in which:

FIG. 1 is a schematic, perspective view of a conventional scanning device;

FIG. 2 is a schematic, perspective view of a scanning device according to an embodiment of the present invention;

FIG. 3 is a longitudinal sectional view of the scanning device of FIG. 2;

FIG. 4 is a cross-sectional view of the scanning device of FIG. 2;

FIG. 5 is a cross-sectional view of a portion of the scanning device of FIG. 4 showing the operation of the scanning device;

FIG. 6 is a schematic, cross-sectional view of a portion of a scanning device according to another embodiment of the present invention; and

FIG. 7 is a schematic, longitudinal view of a portion of the scanning device of FIG. 6.

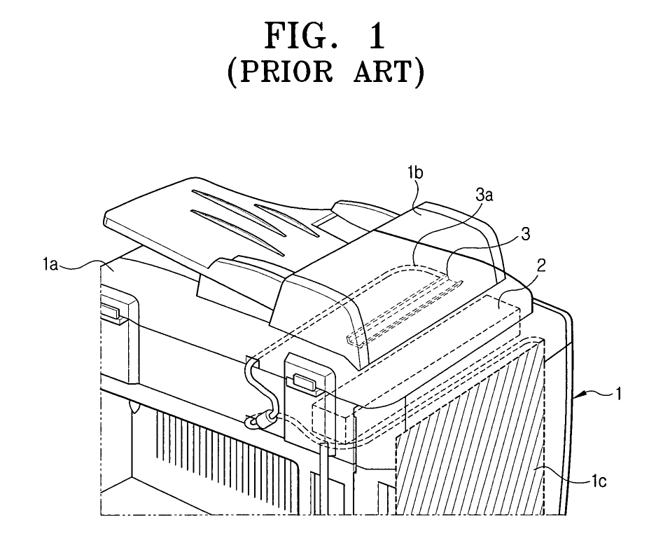

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

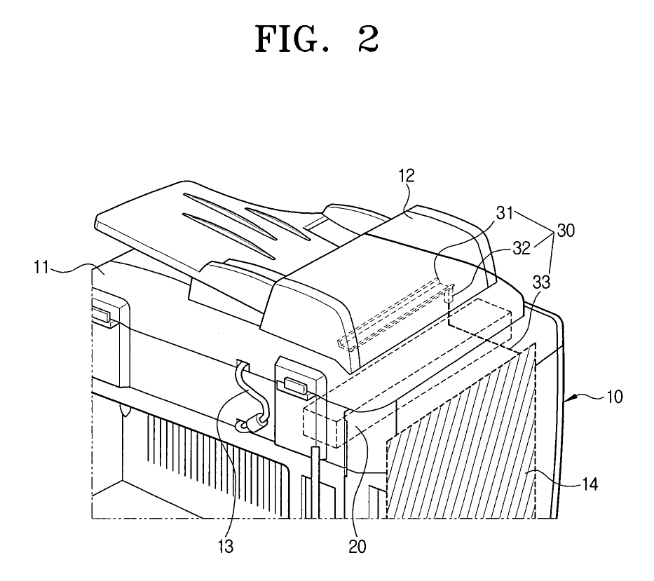

As shown in FIGS. 2 though 4, a scanning device according to an embodiment of the present invention comprises a scanner body 10, a scan unit 20 and a grounding unit 30.

The scanner body 10 comprises a document tray 15 formed as a transparent flat plate, a frame 14 for covering component parts such as a main controller (not shown), and a cover 11 pivotably mounted by a hinge.

The cover 11 has an automatic document feeder 12 for supplying documents to the scanner body 10 sheet by sheet. The automatic document feeder 12 is connected to the frame 14 by a connection cable 13. The connection cable 13 passes outside of the scanner body 10.

The scan unit 20 is movably mounted under the document tray 15 to scan an image of the document.

The grounding unit 30 selectively grounds radiated electromagnetic interference (EMI) from the scan unit 20 to the frame 14 according to the opening and closing of the cover 11. The grounding unit 30 comprises a grounding member 31, a driving member 32, and a grounding cable 33.

The grounding member 31 is mounted to the cover 11 to face the scan unit 20 and is disposed on the moving path of a document supplied by the automatic document feeder 12. Radiated EMI generated by the scan unit 20 is absorbed by the grounding member 31 when the cover 11 is closed. The grounding member 31 is preferably a shading member which is disposed opposite to the scan unit 20 to perform shading compensation such as white level compensation. In this embodiment, a white bar is used as the shading member.

The shading member, that is, the grounding member 31, is made of metal and comprises a coated portion ‘a’ preferably coated with a white color and a non-coated portion ‘b’ that contacts the driving member 32. The radiated EMI absorbed by the grounding member 31 is effectively grounded to the driving member 32 through the non-coated portion ‘b’ that is preferably made of only metal. The non-coated portion ‘b’ is preferably in an area which does not offer a shading reference to the scan unit 20.

The driving member 32 is movably mounted on the scanner body 10 to contact the grounding member 31 and comprises a ball 32a and a spring 32b. The ball 32a contacts the grounding member 31 while the spring 32b biases the ball 32a toward the cover so that it is pressed against the grounding member 31 when the cover 11 is closed.

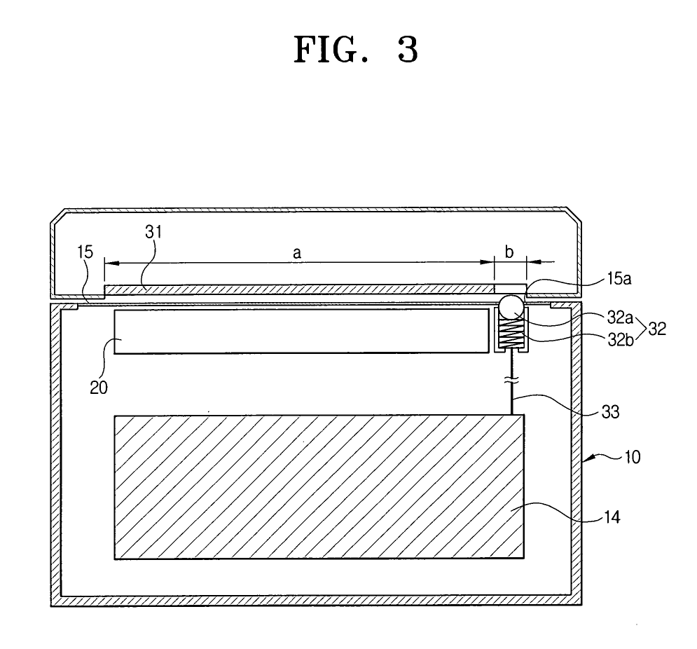

In addition, the driving member 32 is placed on one side of the document tray 15 and the scan unit 20, as shown in FIG. 3 so that it does not obstruct the document tray 15 and the scan unit 20 while still contacting an end of the grounding member 31.

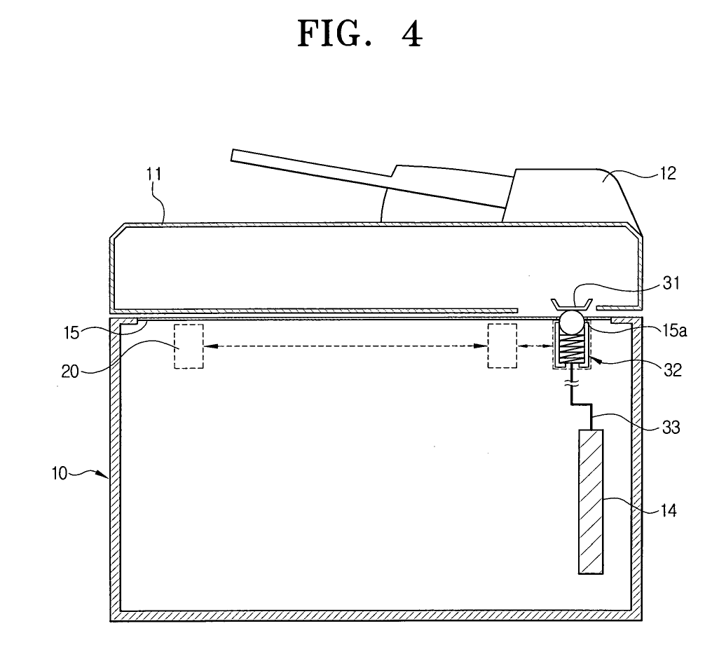

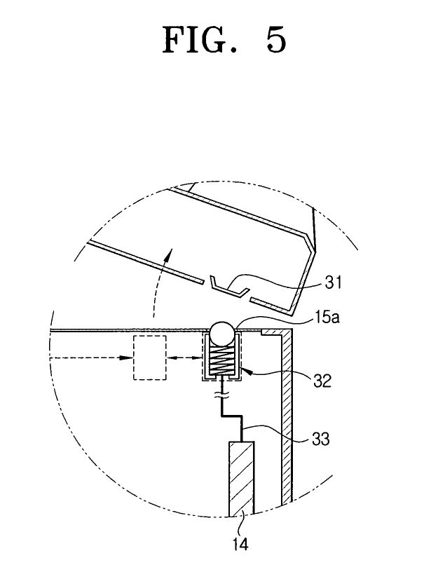

The document tray 15 is disposed between the driving member 32 and the grounding member 31, and the driving member 32 moves through an opening 15a of the document tray 15. When the cover 11 is closed, the ball 32a contacts the grounding member 31 as shown in FIG. 4, thereby grounding the radiated EMI of the scan unit 20. When the cover 11 is open, in contrast, the ball 32a does not contact the grounding member 31, as shown in FIG. 5.

The grounding cable 33 connects the driving member 32 and the frame 14. To shorten the path between the driving member 32 and the frame 14 within the scanning device, the grounding cable 33 is connected to a dedicated connection cable 13 that passes outside of the scanning device, as shown in FIG. 2. The grounding cable 33 is made of metal for grounding radiated EMI.

In the above-described structure, when the cover 11 is closed, the grounding member 31 (which includes the shading bar) absorbs radiated EMI. The absorbed radiated EMI is grounded to the frame 14 of the scanner body 10 through the driving member 32 that contacts the grounding member 31 when the cover 11 is closed and the grounding cable 33 that is connected to the driving member 32.

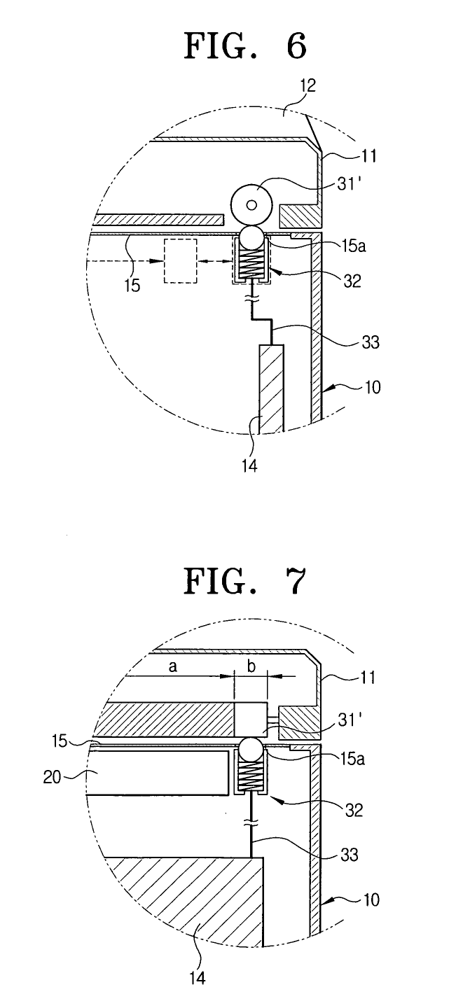

FIGS. 6 and 7 show another embodiment of the present invention. In this embodiment, a scanning device comprises a scanner body 10, a scan unit 20 and a grounding unit 30. Since the scanner body 10, the scan unit 20 and the grounding unit 30 have a similar structure as those described in reference to FIGS. 2 through 4, a detailed description is omitted for clarity and conciseness.

In this embodiment, a grounding member 31′ of the grounding unit 30 has a white roller 31′. Like the grounding member 31 with a white bar described with respect to the first embodiment, the white roller 31′ serves as a shading member for providing a reference for shading compensation to the scan unit 20. The white roller 31′ comprises a coated portion ‘a’ coated with a white color and a non-coated portion ‘b’ with an exposed metal portion.

The driving member 32 selectively contacts the non-coated portion ‘b’ of the white roller 31 and the grounding cable 33. Thus, the radiated EMI of the scan unit 20 is grounded in the shortest distance.

Thus, by connecting the grounding member 31′ and the frame 14 by the shortest distance, the induction of radiated EMI is minimized. Therefore, the radiated EMI is efficiently grounded.

As can be appreciated from the above described embodiments of the present invention, the radiated EMI generated by the scan unit 20 is effectively grounded by shortening the connection distance between the grounding member 31 or 31′ and the frame 14, thereby preventing the grounding member 31 or 31′ from absorbing radiated EMI and becoming another source of radiated EMI. Also, because the grounding member 31 or 31′ includes the shading member opposite to the scan unit 20, grounding is performed without a dedicated grounding member, thereby saving manufacturing costs. Moreover, since the grounding member 31 or 31′ is selectively contacted by the driving member 32 rather than by a dedicated means such as a screw, the manufacturing process is simplified.

While the invention has been shown and described with reference to certain embodiments thereof, it will be understood by those skilled in the art that various changes in form and details may be made therein without departing from the spirit and scope of the invention as defined by the appended claims.

What is claimed is:

1. A scanning device comprising:
a scanner body including a frame;
a cover pivotably mounted to the scanner body so that it can be opened and closed;
a scan unit mounted to the scanner body for scanning an image of a document; and
a grounding unit for grounding noise radiated from the scan unit to the frame to eliminate the noise, the grounding unit being selectively connected to the frame by the opening and closing of the cover.

2. The scanning device of claim 1, wherein the grounding unit comprises:
a grounding member mounted to the cover to face the scan unit;
a driving member movably mounted to the scanner body so that is can contact the grounding member; and
a grounding cable connecting the driving member and the frame.

3. The scanning device of claim 2, wherein the driving member comprises:
a ball contacting the grounding member; and
a spring biasing the ball into contact with the grounding member when the cover is closed.

4. The scanning device of claim 2, wherein the grounding member serves as a shading member to provide a reference for shading compensation to the scan unit.

5. The scanning unit of claim 4, wherein the shading member is a white bar.

6. The scanning unit of claim 4, wherein the shading member is a white roller.

7. The scanning device of claim 2, wherein the cover has an automatic document feeder for supplying documents to an upper part of the scan unit sheet by sheet, and the grounding member is disposed on a moving path of a document being supplied by the automatic document feeder.

8. The scanning device of claim 2, wherein a document tray is mounted to the scanner body so that documents can be stacked thereon, the document tray being disposed between the grounding member and the driving member.

9. The scanning device of claim 8, wherein the document tray has an opening for the driving member to move through.

10. The scanning device of claim 3, wherein the grounding member comprises a non-coated portion for contacting the driving member and a coated portion disposed opposite to the scan unit and coated with a certain color.

11. The scanning device of claim 9, wherein the driving member is inclined to one side of the document tray and the scan unit.

12. A scanning device comprising:
a scanner body including a frame;
a cover pivotably mounted to the scanner body so that it can be opened and closed;
a scan unit mounted to the scanner body to scan an image of a document;
a shading member mounted to the cover to provide a reference for shading compensation to the scan unit; and
a grounding unit for selectively grounding the shading member to the frame by the opening and closing of the cover.

13. The scanning device of claim 12, wherein the grounding unit comprises:
a driving member movably mounted to the scanner body to contact the shading member; and
a grounding cable for connecting the driving member and the frame.

14. The scanning device of claim 13, wherein the driving member comprises:
a ball contacted with the shading member; and
a spring biasing the ball into contact with the grounding member when the cover is closed.

15. The scanning device of claim 12, wherein the shading member is a white bar.

16. The scanning unit of claim 12, wherein the shading member is a white roller.
